(19) United States
(12) Patent Application Publication
(10) Pub. No.: US 2009/0198694 A1
(43) Pub. Date: Aug. 6, 2009

(54) Resolving conflicts in a transactional execution model of a multiprocessor system

(76) Inventor: Tessil Thomas, Bangalore (IN)

Correspondence Address: TROP, PRUNER & HU, P.C., 1616 S. VOSS RD., SUITE 750, HOUSTON, TX, 77057-2631, US

(21) Appl. No.: 12/012,060

(22) Filed: Jan. 31, 2008

(51) Int. Cl. G06F 17/30

(52) U.S. Cl. 707/8; 707/E17.007

(57) ABSTRACT

In one embodiment, the present invention includes a method for resolving conflicts, including receiving data access requests from multiple requestors at a home agent that owns the data, determining whether any of the requests are transactional requests, any of the requestors obtains the data forwarded from another agent, and a highest priority transactional requestor, and based at least in part on the determining, sending from the home agent a first message to the highest priority transactional requestor to indicate that the highest priority transactional requestor is to not abort its transaction and a second message to the other requestor to indicate that the corresponding requestor is to abort its transaction. Other embodiments are described and claimed.

### BACKGROUND

In many computer systems, and particularly multiprocessor computer systems, multiple threads may execute simultaneously. Such simultaneous execution can raise various issues with regard to maintaining consistency and avoiding conflicts between the different threads.

One execution model to handle such multiple threads is a so-called transactional execution model. In a system where transactional execution is supported, access to shared data structures can be achieved without contending for locks. To effect such execution, regions of a thread referred to as a “transaction” are identified. The beginning and end of a transaction are marked by special instructions. The execution within a region of code marked as a transaction is speculative until the instruction marking the end of transaction is retired. All loads and stores within a transaction are cached or buffered and marked as tentative. If there is an access to any of these tentatively accessed addresses from other threads in the system, if the requestor has higher priority, the transaction will be aborted and the program restarted at the beginning of the transaction. This can be used for lock-free execution of parallel threads and speculative parallelization of sequential code. However, such transactional execution can suffer from performance drawbacks where different transactions contend, causing excessive aborts and restarts of transactions. Furthermore, many system implementations are not designed to handle transactional execution. This is particularly so in a multiprocessor system having different agents connected via point-to-point (PTP) interconnects.

### BRIEF DESCRIPTION OF THE DRAWINGS

FIG. 1 is a block diagram of a system in accordance with one embodiment of the present invention.

FIG. 2 shows a general socket architecture of a socket in accordance with one embodiment of the present invention.

FIGS. 3A and 3B show a flow diagram of an example processing home agent in accordance with one embodiment of the present invention.

### DETAILED DESCRIPTION

In various embodiments, a technique for ensuring conflict resolution between memory accesses from transactions in different threads in a multi-socket platform may be provided. More specifically, various embodiments may be used in a multiprocessor system having sockets connected via PTP interconnects and implementing a distributed shared memory system. In this way, transactional execution may adhere to a system having a given distributed shared memory system, enabling faster processing of multi-threaded software. In addition to handling conflicts between transactional requests, embodiments may further provide for handling of conflicts between non-transactional and transactional requests, as well as for handling conflicts between transactional requests in caching accesses. Still further, embodiments may enable transaction abort and commit handling in accordance with this conflict handling model.

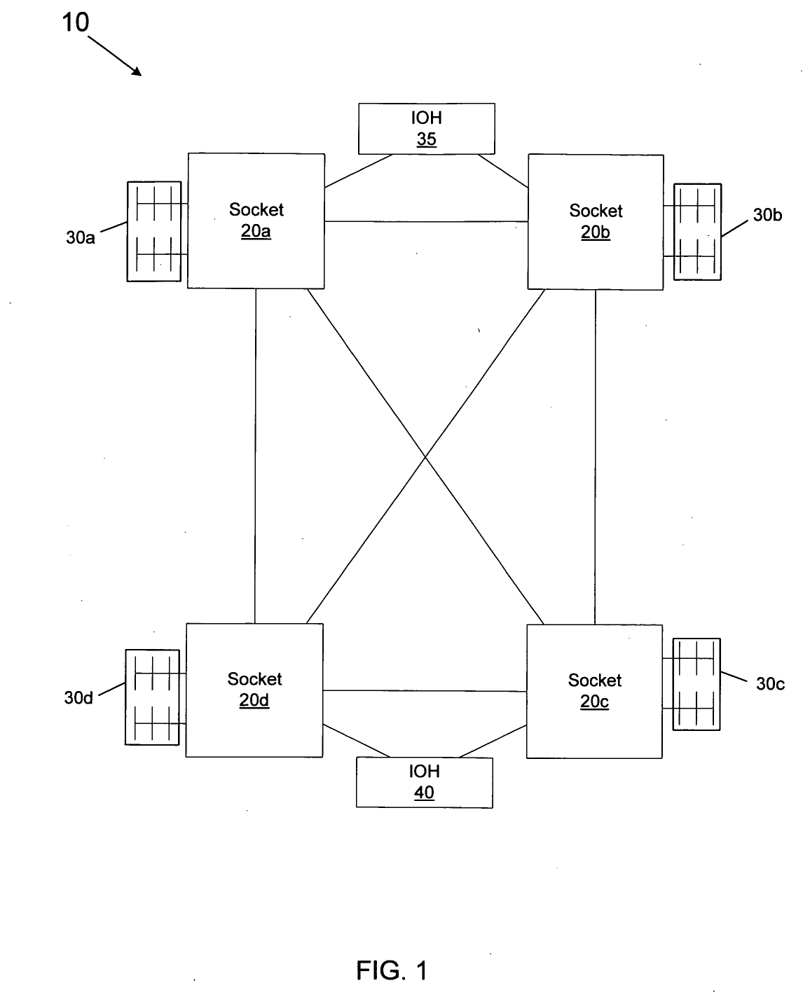

Referring now to FIG. 1, shown is a block diagram of a system in accordance with one embodiment of the present invention. As shown in FIG. 1, system 10 may be a multi-processor system including a plurality of sockets 20a-20_{d} (generically socket 20). In various embodiments, each socket may include multiple cores as will be discussed further below. As further shown in FIG. 1, each socket 20 may be coupled to a memory 30ₐ-30_{d} (generically memory 30), which may be a dynamic random access memory (DRAM) in one embodiment. Memory 30 may be a distributed shared memory. As further shown in FIG. 1, a pair of input/output (IO) hubs (IOH) 35 and 40 may be coupled between sockets 20ₐ and 20_{b} and 20_{c} and 20_{d}, respectively. Note that FIG. 1 shows a system implementation in which the various components are each connected by a PTP interconnect. In one embodiment, such interconnects may be common system interface (CSI) links, although the scope of the present invention is not limited in this regard.

Generically, the various sockets, hubs and other components that may be present in a system such as shown in FIG. 1 may be referred to herein as processors or agents. Furthermore, within such processors or agents, one or more specialized engines or agents such as home agents, caching agents and so forth may be present. Using embodiments of the present invention, as will be discussed below, conflict resolution when multiple requestors of these agents seek access to the same data, such as a cache line, can be resolved. As one example, in the distributed memory system of FIG. 1, while data may be owned by a given memory portion 30 associated with a given socket (and a corresponding home agent therein), copies of that data may also be present in one or more caching agents, e.g., cache memories of other sockets. Still further, additional requestors such as other sockets, may request copies of such data. Using embodiments of the present invention, conflicts between such multiple requestors can be resolved. While shown with this particular implementation in the embodiment of FIG. 1, the scope of the present invention is not limited in this regard.

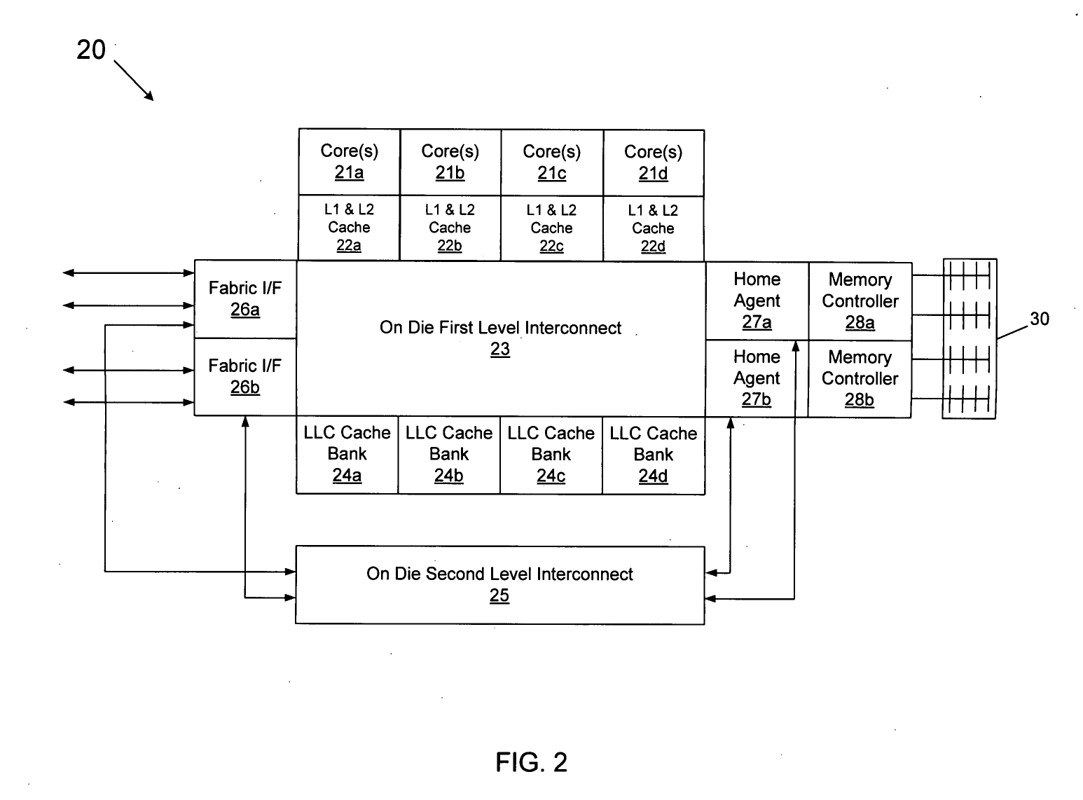

FIG. 2 shows a general socket architecture of a socket 20 in accordance with one embodiment of the present invention. As shown in FIG. 2, socket 20 may include a plurality of cores 21ₐ-21_{d}. Such cores may be coupled to multiple levels of cache memories, such as caches 22ₐ-22_{d}, which may be level 1 and level 2 (L1 and L2) caches. In turn, these caches may be coupled to an on-die first level interconnect 23, which may interconnect caches 22 to a last level cache (LLC) cache bank 24ₐ-24_{d}, and various other on-die components, including fabric interfaces 26ₐ and 26_{b} and home agents 27ₐ and 27_{b}. As shown in FIG. 2, interfaces 26 and home agent 27 may further be coupled to an on-die second level interconnect 25. Home agents 27 may further be coupled to memory controllers 28ₐ and 28_{b}, which in turn are coupled to memory 30. Fabric interfaces 26ₐ and 26_{b} may be coupled to various PTP interconnects which in turn may be coupled to other sockets, IO agents or other such system components. While shown with this particular implementation in the embodiment of FIG. 2, the scope of the present invention is not limited in the regard. In this architecture, the cores 21 and the distributed last level cache banks 24 are connected to each other within the socket by either a ring interconnect or a two dimensional mesh/crossbar on-die interconnect protocol 23. Each core 21 may be multi-threaded. Each cache bank controller also acts as a CSI caching agent interface for requests mapped to that cache bank. Memory controller 28 is integrated into the processor die, and a CSI protocol is used for inter-processor communication and IO access. Second level on-die interconnect 25 allows fast remote socket to memory and memory to remote socket data transfer without adding traffic on first level on-die interconnect 23.

As mentioned earlier any access to a tentatively cached or buffered line will result in aborting either the requesting transaction or the transaction which originally accessed the line tentatively. This essentially is a conflict condition that can occur between one or more transactions, or between transactions and non-transactional requests. This conflict can occur at any point in the cache hierarchy. There are two conflict scenarios: (1) a transaction has already tentatively accessed the line and a new request comes for the same line; and (2) a line is being requested by one or more transactions and/or by non-transactional threads at the same time. This conflict resolution is especially relevant when there is more than one request for ownership of the line.

For resolving conflicts in both scenarios, a request has to be tagged as transactional or non-transactional and a transactional request may have a priority identifying tag. This priority identifying tag can be: (1) a time stamp indicating the transaction's age; (2) a sequence number assigned by software; or (3) a retry count, indicating the number of times the transaction has been aborted. In the first instance the oldest transaction will be given priority. If the age of two conflicting transactions is the same, then a transaction will be randomly chosen. In the second instance, the transaction with lowest sequence number will be given priority. If the sequence number of two conflicting transactions are the same, then a transaction will be randomly chosen. In the third instance, the transaction with the highest retry count will be given priority. If the retry count of two conflicting transactions are the same, then a transaction will be randomly chosen.

In addition for proper conflict resolution the snoop response, completion and complete forward may have an “abort bit” in the message packet. The caching agent will send a special “abort” response to the requesting transaction's thread on getting a completion or complete forward with the abort bit set for a request belonging to that transaction. This abort bit may also be present in the snoop response that a cache sends back to the requester. Transactional accesses can be cached in a L1 or L2 cache of each processor core. The L1 cache of each processor core may be shared by all the threads in that core.

The following conflict resolution rules may apply for the case where some of the conflicting requests are for exclusive ownership and some are for non-exclusive (i.e., shared) data access. These rules apply also for the case when all the conflicting requests are for exclusive ownership of the line. For cases where all the requests are for non-exclusive data access, other conflict resolution rules can be applied. Here “transactional request” means a request which has originated from a thread executing a transactional region of code.

First, if there are a set of requests inflight to the same line, and if all of them are transactional and if one of the requestors gets the line forwarded from another agent and if it is the highest priority transactional requester, then the home agent will send a completion message (with the abort bit not set) to the highest priority transactional requestor. The home agent will send a completion to all the other requestors with the abort bit set, thereby aborting those transactions.

Second, if there are a set of requests inflight to the same line, and if all of them are transactional and if one of the requestors gets the line forwarded from another agent and if it is not the highest priority transactional requester, then the home agent will extract the line from the requestor who got the line by sending a complete forward with the abort bit set. This sends the line to highest priority transactional requestor. Then the home agent will send a completion message (with the abort bit not set) to the highest priority transactional requester. The home agent will send a completion to all the other requesters with the abort bit set, thereby aborting those transactions.

Third, if there are a set of requests inflight to the same line, and if all of them are transactional and none of them gets the line forwarded from another agent, then the home agent will send data and a completion message (with the abort bit not set) to the highest priority transactional requestor. The home agent will send a completion to all the other requestors with the abort bit set, thereby aborting those transactions.

Fourth, if there are a set of requests inflight to the same line and if they are a mix of transactional and non-transactional requests and if one of the requesters gets the line forwarded from another agent and it is a non-transactional request, then the home agent will order the conflict chain such that all the non-transactional requests are at the beginning of the conflict chain. Once all the non-transactional requests have completed, it will force the last non-transactional request to forward the data to the highest priority transactional requester. Then the home agent will send a completion message (with abort bit not set) to the highest priority transactional requestor. The home agent will send a completion to all the other transactional requestors with the abort bit set, thereby aborting those transactions.

Fifth, if there are a set of requests inflight to the same line and if they are a mix of transactional and non-transactional requests and if one of the requestors gets the line forwarded from another agent and it is a transactional request, and it is not the highest priority transactional request, then the home agent will extract the line from the requestor who got the forwarded line by sending a complete forward with the abort bit set. The home agent will order the conflict chain such that all the non-transactional requests follow immediately after this transactional request which got the line forwarded. Once all the non-transactional requests have completed, the home agent will force the last non-transactional request to forward the data to the highest priority transactional requestor. Then the home agent will send a completion message (with abort bit not set) to the highest priority transactional requester. The home agent will send a completion to all the other transactional requestors with the abort bit set, thereby aborting those transactions.

Sixth, if there are a set of requests inflight to the same line and if they are a mix of transactional and non-transactional requests and if one of the requestors gets the line forwarded from another agent and it is a transactional request, and it is the highest priority transactional request, then the home agent will extract the line from the requester who got the forwarded line by sending a complete forward with the abort bit set, thereby aborting the parent transaction. The home agent will order the conflict chain such that all the non-transactional requests follow immediately after this transactional request which got the line forwarded. The home agent will send a completion to all the other transactional requestors with the abort bit set, thereby aborting those transactions.

Seventh, if there are a set of requests inflight to the same line and if they are a mix of transactional and non-transactional requests and there is no forwarding of the cache line to any of the requestors, then home agent will order the conflict chain such that all the non-transactional requests are at the beginning of the conflict chain. Once all the non-transactional requests have completed, the home agent will force the last non-transactional request to forward the data to the highest priority transactional requester, and then it will send a completion message (with the abort bit not set) to the highest priority transactional requestor. The home agent will send a completion to all the other transactional requestors with the abort bit set, thereby aborting those transactions.

Eighth, if there are a set of requests inflight to the same line and one of them is a writeback request (which is always non-transactional) and other requests are a mix of transactional and non-transactional requests, then the home agent will order all the requests such that the writeback is completed first and then all the non-transactional requests are completed and then it will force the last non-transactional request to forward the data to the highest priority transactional requester, and then it will send a completion message (with the abort bit not set) to the highest priority transactional requester. The home agent will send a completion to all the other transactional requesters with the abort bit set, thereby aborting those transactions.

Ninth, if there are a set of requests inflight to the same line and one of them is a writeback request and all others are transactional requests, then the home agent will order all the requests such that the writeback is completed first and then it will send a completion message (with the abort bit not set) to the highest priority requestor. The home agent will send a completion to all the other transactional requestors with the abort bit set, thereby aborting those transactions.

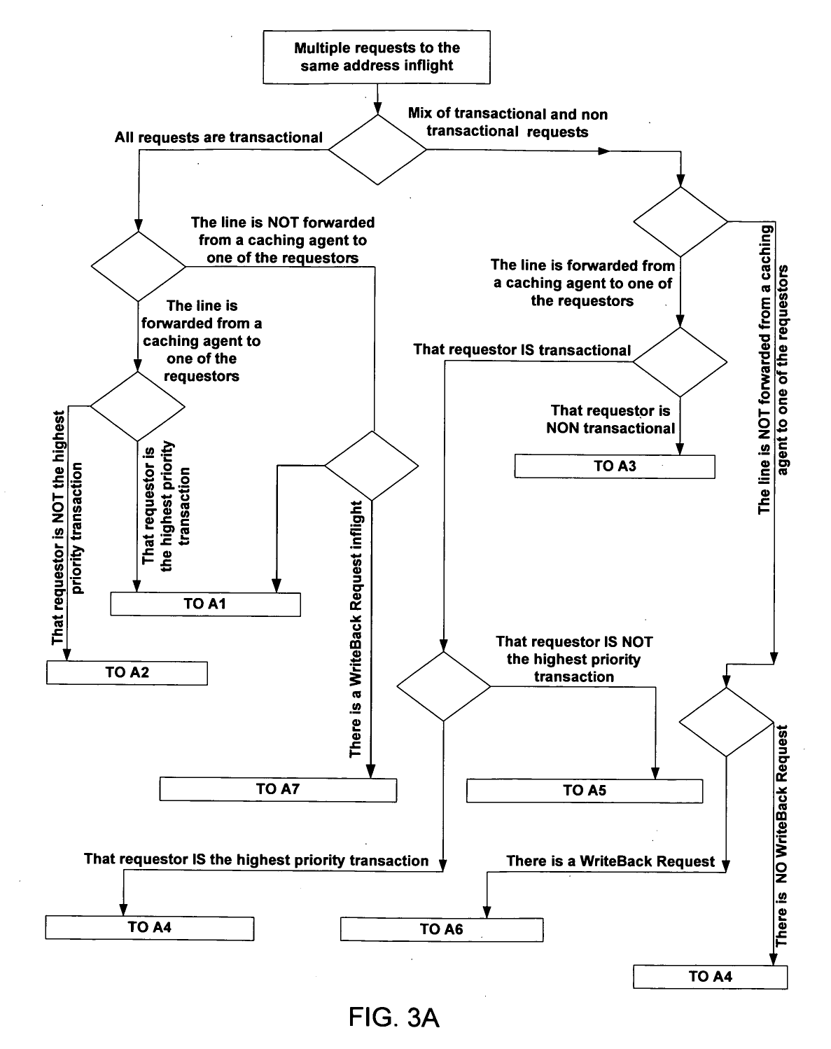

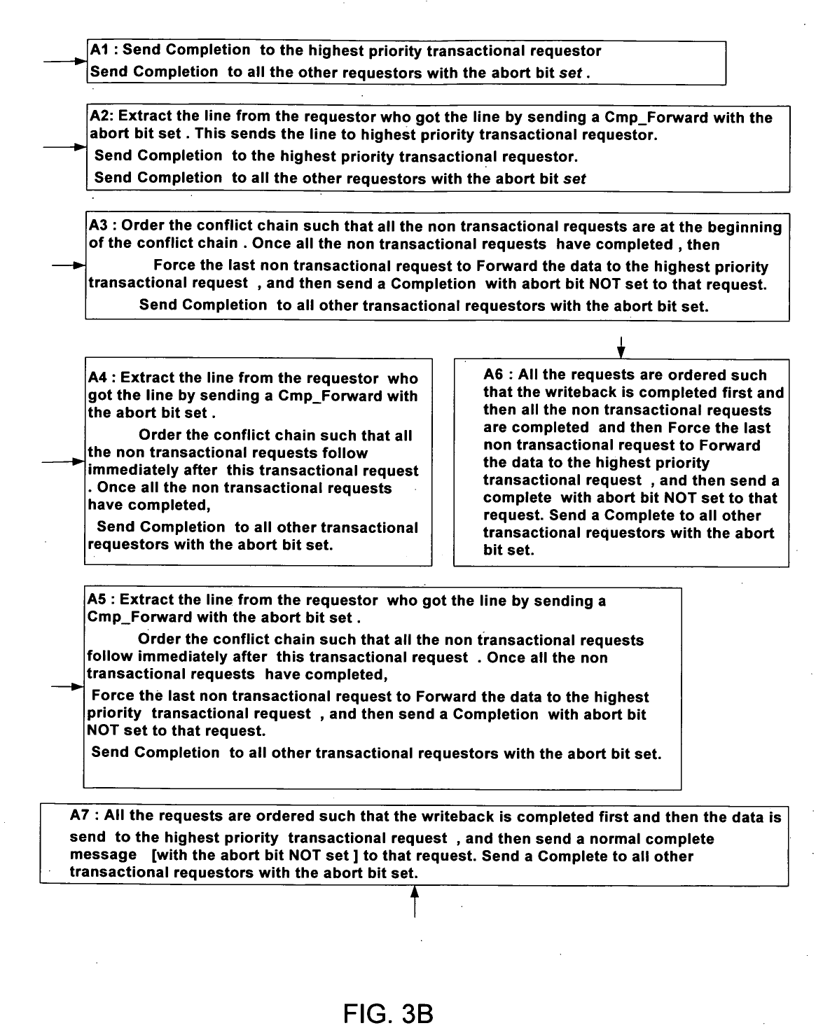

FIGS. 3A and 3B set forth a flow diagram of example processing by a home agent to implement these conflict ordering rules.

For certain caching agents, the acknowledgement-conflict phase might be absent for a transactional request, i.e., it might get a completion with or without the abort bit set even though it has observed a conflicting request from another agent. On such an event if data is available and the abort bit is not set, then a completion (no-error) response will be send to the requesting thread along with the data. If the abort bit is set, then a special abort response is send back to the requesting thread. In addition, the caching agent might get a complete forward with abort bit set for a transactional request. So for transactional requests, the caching agent should not forward the data to the requesting thread until a completion message is received from the home agent.

Regarding abort event handling, an abort event is considered at the first available accept traps/accept interrupts window. The abort response to a load or a store is considered at the retirement point of that load or store. Once a transaction gets an abort request or event, the corresponding thread is stalled, and the L1 cache lookup pipeline is blocked from accepting any new requests. The abort handler waits until all pending memory access requests are completed for that thread. Once all the pending requests have completed, the transaction's cache lines in the L1 cache will be invalidated.

Alternatively, the abort handler can block the L1 cache lookup pipeline and proceed with the invalidation immediately after the L1 cache lookup pipeline is drained. Pending memory access requests from the aborting transaction which complete normally (i.e., without abort bit set) will update the cache as non-transactional requests. Once in the abort handler, any new abort request that might come in for the accesses still inflight are ignored. Once the L1 invalidation for the transaction is complete, a checkpoint handler is called, which will restart the execution from the beginning of the first transaction in the thread.

Regarding transaction commit handling, the transaction “end” instruction is executed only after all preceding instructions retire. Once the transaction “ending” instruction is executed, the L1 cache lookup pipeline is blocked from accepting any new requests. Then all the cache lines belonging to this thread in the L1 cache is made non-transactional by resetting the transactional bit. Then the cache lookup pipeline is unblocked and the instruction retires.

Caches may have various properties to handle conflict resolution in accordance with an embodiment of the present invention. For example, the tag of each cache line may have a bit indicating whether it is transactional or not, and the transaction's hardware thread identification (thread ID). Each cache bank may have a priority number content addressable memory (CAM), which will have the priority number associated with all the transactions that have lines in that bank. Each entry of this CAM will have a transaction's thread ID and the priority number of that transaction. This CAM may be accessed using the thread ID of a transaction, which may uniquely identify the priority to be used for conflict resolution when a snoop comes in from an external caching agent. When a snoop comes in, first the tag is read, which gives the thread ID of the transaction that owns the line. Then this thread ID is used to CAM the priority number CAM. The priority number obtained from the matching entry in the CAM is used for the conflict resolution. If the snoop has a lower priority and if the request is for exclusive ownership or if the line is in the exclusive state, then the snoop response will be a miss and the abort bit will be set in the response.

Thus, the caching agent will send out the snoop response to the home agent with the abort bit set. The home agent on seeing a response with the abort bit set, will send the completion to the requestor with the abort bit set. If the snoop has higher priority, then the thread (i.e., transaction) that is the owner of the line will get an abort event. Each time a transactional line is newly written into the cache, the priority number CAM is CAM'ed with the thread ID of the requestor and if there is no match, then the priority number of that transaction is written into the CAM along with the thread ID.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a plurality of requests for access to data from a plurality of requesters at a home agent that owns the data;
determining whether any of the requests are transactional requests, any of the requesters obtains the data forwarded from another agent, and a highest priority transactional requester; and
based at least in part on the determining, sending from the home agent a first completion message to the highest priority transactional requester with an abort indicator having a first state to indicate that the highest priority transactional requestor is to not abort its transaction, and sending a second completion message to all other of the plurality of requesters with the abort indicator having a second state to indicate that the corresponding requestor is to abort its transaction.

2. The method of claim 1, wherein if one of the other requesters obtains the data forwarded from another agent, extracting the data from the one other requestor via a completion forward message from the home agent with the abort indicator having the second state.

3. The method of claim 2, further comprising transmitting the completion forward message prior to transmitting the first completion message.

4. The method of claim 1, wherein if the plurality of requests includes a mix of transactional requests and non-transactional requests, and one of the non-transactional requestors obtains the data forwarded from another agent, ordering a conflict chain in the home agent so that the non-transactional requests proceed first and a last one of the non-transactional requesters forwards the data to the highest priority transactional requestor.

5. The method of claim 1, wherein if the plurality of requests includes a mix of transactional requests and non-transactional requests, and one of the transactional requestors obtains the data forwarded from another agent, ordering a conflict chain in the home agent so that the non-transactional requests proceed after the transactional request that obtains the forwarded data, and a last one of the non-transactional requestors forwards the data to the highest priority transactional requestor.

6. The method of claim 1, wherein if the plurality of requests includes a mix of transactional requests and non-transactional requests, and the data is not forwarded to any of the plurality of requesters, ordering a conflict chain in the home agent so that the non-transactional requests proceed first and a last one of the non-transactional requesters forwards the data to the highest priority transactional requestor.

7. The method of claim 6, further comprising sending the first completion message to the highest priority transactional requestor after the data is forwarded from the last non-transactional requestor.

8. A system comprising:
a first processor including a home agent associated with a first distributed memory portion;
a second processor coupled to the first processor by a first point-to-point (PtP) link, the second processor including a caching agent to cache a copy of data of the first distributed memory portion;
a third processor coupled to the first processor by a second PtP link, wherein the home agent is to receive a plurality of requests for access to the data, resolve a conflict between the plurality of requests based on conflict resolution rules, and based at least in part on the resolution, send from the home agent a first completion message to a highest priority transactional requestor with an abort indicator having a first state to indicate that the highest priority transaction requester is to not abort its transaction, and send a second completion message to all other of the plurality of requestors with the abort indicator having a second state to indicate that the corresponding requestor is to abort its transaction.

9. The system of claim 8, wherein the conflict resolution rules are to be applied based on an analysis including determining whether any of the requests are transactional requests, any of the requestors obtains the data forwarded from another processor, and the highest priority transactional requestor.

10. The system of claim 9, wherein if one of the other requesters obtains the data forwarded from another processor, the home agent is to extract the data from the one other requestor via a completion forward message from the home agent with the abort indicator having the second state.

11. The system of claim 10, wherein the home agent is to transmit the completion forward message prior to transmission of the first completion message.

12. The system of claim 9, wherein if the plurality of requests includes a mix of transactional requests and non-transactional requests, and one of the non-transactional requesters obtains the data forwarded from another processor, the home agent is to order a conflict chain so that the non-transactional requests proceed first and a last one of the non-transactional requesters forwards the data to the highest priority transactional requestor.

13. The system of claim 9, wherein if the plurality of requests includes a mix of transactional requests and non-transactional requests, and one of the transactional requesters obtains the data forwarded from another processor, the home agent is to order a conflict chain so that the non-transactional requests proceed after the transactional request that obtains the forwarded data, and a last one of the non-transactional requesters forwards the data to the highest priority transactional requestor.

14. The system of claim 9, wherein if the plurality of requests includes a mix of transactional requests and non-transactional requests, and the data is not forwarded to any of the plurality of requesters, the home agent is to order a conflict chain so that the non-transactional requests proceed first and a last one of the non-transactional requestors forwards the data to the highest priority transactional requester.

15. The system of claim 14, wherein the home agent is to send the first completion message to the highest priority transactional requestor after the data is forwarded from the last non-transactional requester.
